(19) United States
(12) Patent Application Publication
(10) Pub. No.: US 2021/0366045 A1
(43) Pub. Date: Nov. 25, 2021

(54) ADAPTIVE GOAL IDENTIFICATION AND TRACKING FOR VIRTUAL ASSISTANTS

(71) Applicant: Wells Fargo Bank, N.A., San Francisco, CA (US)

(72) Inventors: Michelle M. Young, Houston, TX (US); Paul Vittimberga, Oakland, CA (US); Wayne Barakat, Novato, CA (US); David Newman, Walnut Creek, CA (US); Vincent Le Chevalier, San Jose, CA (US); Brian P. McMahon, Berkeley, CA (US)

(21) Appl. No.: 15/797,857

(22) Filed: Oct. 30, 2017

(51) Int. Cl. G06Q 40/06; G06Q 50/00

(52) U.S. Cl. CPC G06Q 40/06; G06Q 50/01

(57) ABSTRACT

Among other things, embodiments of the present disclosure can help improve the functionality of virtual assistant (VA) systems by identifying various goals for a user (e.g., with regard to the user's employment, fitness, health, finances, etc.) and steps that can be taken by the user and/or the VA to achieve such goals. Additionally, embodiments of the present disclosure help users track progress on their goals and provide recommendations and information to help users achieve their goals.

### BACKGROUND

The popularity of virtual assistants (VAs) continues to grow. Virtual assistants are software-implemented systems that interact with users (often via voice recognition) to answer questions and perform tasks and services for users. Virtual assistants can be valuable assets in helping users to maximize their time and achieve their goals (such as employment-related goals, fitness and health goals, financial goals, etc.). Conventional VAs, however, are typically dependent on a user instructing the VA to take specific actions, and do not automatically identify goals for the user (or perform tracking thereof) without user intervention. Embodiments of the present disclosure address these and other issues.

### BRIEF DESCRIPTION OF THE DRAWINGS

In the drawings, which are not necessarily drawn to scale, like numerals can describe similar components in different views. Like numerals having different letter suffixes can represent different instances of similar components. Some embodiments are illustrated by way of example, and not of limitation, in the figures of the accompanying drawings, in which:

FIG. 1A illustrates a block diagram of an exemplary system according to various aspects of the disclosure;

FIG. 1B illustrates a block diagram of a virtual assistant operating on a computing device according to various aspects of the disclosure;

FIG. 2 is a flow diagram of an exemplary process according to various aspects of the disclosure; and

FIG. 3 is a block diagram of an exemplary machine according to various aspects of the disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Among other things, embodiments of the present disclosure can help improve the functionality of virtual assistant (VA) systems by identifying various goals for a user (e.g., with regard to the user's employment, fitness, health, finances, etc.) and steps that can be taken by the user and/or the VA to achieve such goals. Additionally, embodiments of the present disclosure help users track progress on their goals and provide recommendations and information to help users achieve their goals.

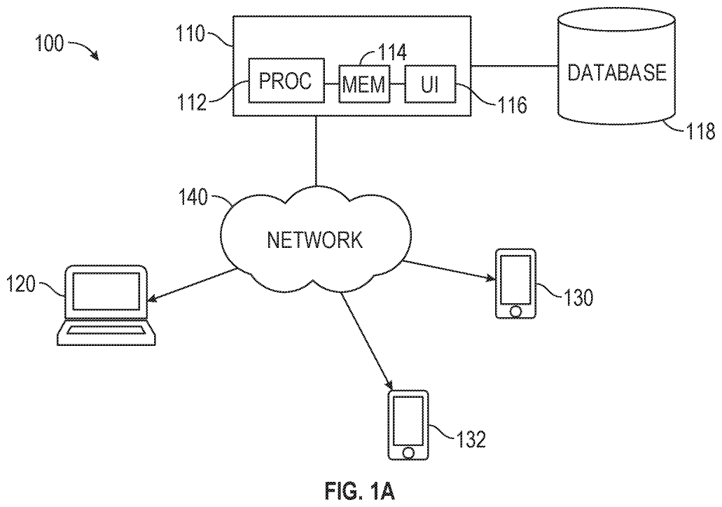

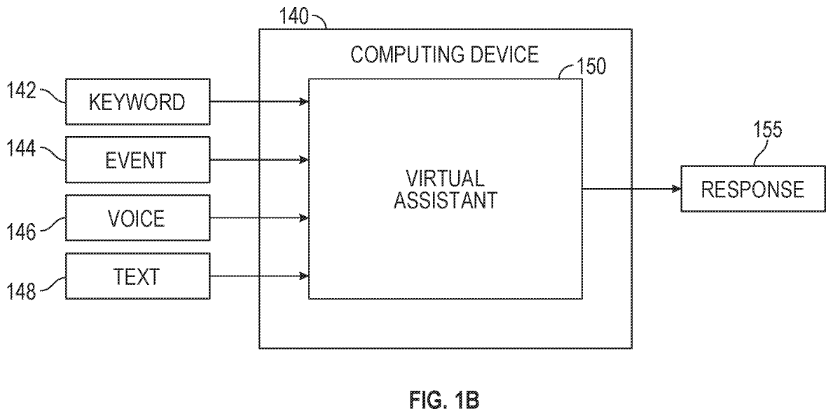

FIG. 1A is a block diagram of system which may be used in conjunction with various embodiments. While FIG. 1A illustrates various components of a computer system, it is not intended to represent any particular architecture or manner of interconnecting the components. Other systems that have fewer or more components may also be used.

In FIG. 1A, the system 100 includes a server computer system 110 comprising a processor 112, memory 114, and user interface 116. Computer system 110 may include any number of different processors, memory components, and user interface components, and may interact with any other desired systems and devices in conjunction with embodiments of the present disclosure.

The functionality of the computer system 110, including the steps of the methods described below (in whole or in part), may be implemented through the processor 112 executing computer-readable instructions stored in the memory 114 of the system 110. The memory 114 may store any computer-readable instructions and data, including software applications, applets, and embedded operating code. Portions of the functionality of the methods described herein may also be performed via software operating on one or more of the client computing devices 120, 122, 130.

The functionality of the system 110 or other system and devices operating in conjunction with embodiments of the present disclosure may also be implemented through various hardware components storing machine-readable instructions, such as application-specific integrated circuits (ASICs), field-programmable gate arrays (FPGAs) and/or complex programmable logic devices (CPLDs). Systems according to aspects of certain embodiments may operate in conjunction with any desired combination of software and/or hardware components. The processor 112 retrieves and executes instructions stored in the memory 114 to control the operation of the system 110. Any type of processor, such as an integrated circuit microprocessor, microcontroller, and/or digital signal processor (DSP), can be used in conjunction with embodiments of the present disclosure. A memory 114 operating in conjunction with embodiments of the disclosure may include any combination of different memory storage devices, such as hard drives, random access memory (RAM), read only memory (ROM), FLASH memory, or any other type of volatile and/or nonvolatile memory. Data can be stored in the memory 114 in any desired manner, such as in a relational database.

The system 110 includes a user interface 116 that may include any number of input devices (not shown) to receive commands, data, and other suitable input. The user interface 116 may also include any number of output devices (not shown) to provide the user with data, notifications, and other information. Typical I/O devices may include touch screen displays, display screens, mice, keyboards, modems, network interfaces, printers, scanners, video cameras and other devices.

The system 110 may communicate with one or more client computing devices 120, 122, 130 as well as other systems and devices in any desired manner, including via network 140. The system 110 and/or computing devices 120, 122, 130 may be, include, or operate in conjunction with, a laptop computer, a desktop computer, a mobile subscriber communication device, a mobile phone, a personal digital assistant (PDA), a tablet computer, an electronic book or book reader, a digital camera, a video camera, a video game console, and/or any other suitable computing device.

The network 140 may include any electronic communications system or method. Communication among components operating in conjunction with embodiments of the present disclosure may be performed using any suitable communication method, such as, for example, a telephone network, an extranet, an intranet, the Internet, point of interaction device (point of sale device, personal digital assistant (e.g., iPhone®, Palm Pilot®, Blackberry@), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Systems and devices of the present disclosure may utilize TCP/IP communications protocols as well as IPX, Appletalk, IP-6, NetBIOS, OSI, any tunneling protocol (e.g. IPsec, SSH), or any number of existing or future protocols.

The system 110 may include (e.g., in the memory 114) a database, and may communicate with any number of other databases, such as database 118. Any such databases may include a relational, hierarchical, graphical, or object-oriented structure and/or any other database configurations. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically.

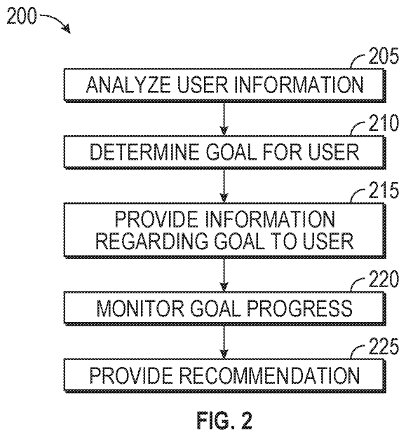

FIG. 2 depicts an exemplary process according to various aspects of the present disclosure. In this example, method 200 includes analyzing information regarding a user via a virtual assistant (205), determining a goal for the user based on the analysis of the information (210), providing information regarding the goal to the user via the virtual assistant (215), monitoring the user's progress in achieving the goal (220), and providing recommendations to the user based on the monitored progress (225). The steps of method 200 may be performed in whole or in part, may be performed in conjunction with some or all of the steps in other methods, and may be performed by any number of different systems, such as the systems described in FIGS. 1A and/or 3.

In the example shown in FIG. 1A for instance, a virtual assistant may be implemented entirely via software operating on a user's computing device 120, 122, or 130, or via a combination of software on a user's computing device in conjunction with software operating on the server computing system 110. In some embodiments, a virtual assistant operates on the server computer system 110 and is accessed via a web-based interface on the user's client computing device 120, 122, 130.

FIG. 1B illustrates one example of a virtual assistant operating on a computing device 140. The computing device 140 may include one or more systems, such as user's computing device 120, 122, 130, and/or server computing system 110. In this example, the virtual assistant 150 is implemented via software operating on the computing device 140. In other embodiments, the virtual assistant may be implemented via hardware, software, or a combination of the two. The virtual assistant 150 receives inputs from a user, namely keyword inputs 142, event inputs 144, voice inputs 146, and/or text inputs 148. The virtual assistant 150 analyzes the inputs and provides a response 155 to the user.

In the method 200 shown in FIG. 2, the system (e.g., server computer system 110 in FIG. 1A) analyzes information regarding a user via a virtual assistant operating on the system (205) and determines a goal for the user (210) based on the analyzed information. For example, the system may analyze information collected from input to the virtual assistant by the user, a financial account associated with the user, posts on social media sites by the user, and other content sources. The system may request authorization from the user (e.g., via the virtual assistant) before accessing any information associated with the user.

In some embodiments, a goal may be identified based on input from the user. Inputs from a user may be received in a variety of different formats, such as text and audio. For example, the virtual assistant may receive an audio input from the user such as “I want to lose twenty pounds.” Though no specific task is given to the virtual assistant to achieve this goal by the user, the system may analyze the input, determine the events and tasks associated with losing weight (e.g., enrolling in a gym membership, increasing physical activity, reducing calorie intake, etc.) and then provide (215) the user with information (e.g., step-by-step daily instructions, work-out regimens, menus) for achieving the user's stated goal.

In another example, the user may provide an audio input to the virtual assistant such as: “I want to pay my bills on time, spend less, and have a credit score greater than 750.” In response, the virtual assistant analyzes the user's input, identifies the goal and the tasks/events necessary to accomplish the goal, and provides (215) a response to the user such as: “I can auto-pay your bills, and decline (or give you alerts) for transactions that are outside your budget.” The user may approve, decline, or modify the proposed actions from the virtual assistant. In yet another example, the customer may say, “I want to go on a vacation.” In response, the VA system may automatically put a varying amount each month based on extraneous funds into the vacation fund. The system may also monitor various vacation-related offers online and alert the user when an offer matching the user's vacation preferences is available.

In some embodiments, the system may identify a plurality of goals for a user, and select a goal to provide the user based on various criteria. For example, the system may identify a conflict between two or more goals, such as the goal of paying the user's bills on time potentially conflicting with the user wanting to save money for a vacation. Conflicts may also be identified between different users of a VA system, such as some partners in a business wishing to allocate funds for a new piece of equipment for the business, while other partners wishing to spend the funds to hire new employees.

The system may select conflicting goals based on input from the user of the VA system, as well as based on a determination of the interests of the user or other factors. For example, where two of three possible goals for a user have a conflict, the system may select the remaining (non-conflicted) goal to present to the user. In other cases, the system may assign a weight or priority to different goals and select a goal having a higher priority or weight to present to the user. For example, the goal of paying the user's bills on time may be given a higher weight/priority by the system than the goal of saving for the vacation.

The system may monitor a user's progress in achieving a goal (220) and provide additional information and recommendations (225) in response to the monitoring to help the user achieve his or her goal. In some embodiments, for example, the virtual assistant may advise the user as to the user's progress in attaining their goal (e.g., “you are 80% of the way to losing twenty pounds”). Additionally or alternatively, the system may adaptively modify the user's goals (or sub-goals constituting a goal) in response to the user's progress. For example, if the user sought to lose twenty pounds in one month, but is two pounds short of that goal after 30 days, the system may modify the goal and underlying sub-goals/tasks for an additional week. In this example, the system may receive data from a user's fitness tracker, direct input from the user, or data from other sources to monitor the user's progress in achieving a goal. Likewise, for financial goals, the system may automatically analyze a user's credit card balances, bank statements, credit information, and other data to monitor a user's progress.

In some embodiments, the system may provide a first recommendation (225) to the user via the virtual assistant at a first time, and monitor the user's progress on achieving the goal subsequent to the first recommendation. If the system determines that the user has failed to execute the first recommendation, the system may follow up with a second recommendation to the user at a later time.

The system may also provide recommendations and other content to a user related to the user's goals based on an analysis of the respective progress of a plurality of other users seeking to achieve the same goal. For example, the system may identify a plurality of other users of the VA system that are attempting to save money for a vacation, and determine that a majority of those who are successfully meeting their savings goals for their vacation are cutting back on the number of times each week that they eat out. Accordingly, the system may provide a recommendation to a user struggling to meet their monthly savings goal to prepare a low-calorie lunch the night before they go to work so the user can save money and meet the user's co-pending goal to lose weight.

For example, if the goal sought by the user is to raise his or her credit score, the system may advise the user to initiate a request with a credit agency to remove an incorrect negative item from the user's credit report. After a week has passed, and the system determines the user has not initiated the request to remove the credit item, the system may follow up with a reminder, a link to the credit agency's website, step-by-step information on removing the credit item, and the like.

In some embodiments, the system may identify actions taken by the user that positively or negatively affect the user attaining goals. In the weight loss goal, for example, the system may determine the user purchased cheesecake at a meal and can provide the user with a warning regarding calorie intake, eating habits, etc. Additionally or alternatively, the system may pre-emptively identify actions the user is likely to take in the future, determine the effect of such actions on the user's goal, and providing recommendations regarding the consequences of the action to the user before the user takes the action. For example, the system may use geolocation information from the user's mobile computing device to determine the user is entering an ice cream store and alert the user that ordering ice cream would exceed the user's target calorie content for the day. Similarly, the system may determine the user is about to enter a clothing store, and alert the user that spending money on clothes could jeopardize satisfaction of the user's monthly-savings goal for a vacation.

The system may, in addition to or as an alternative to sending an alert, take an action to help the user achieve his or her goal. For example, in the case of the system identifying an action the user is about to take that involves an expenditure from a financial account of the user (e.g., the user is about to buy an expensive piece of clothing, thus jeopardizing his or her goal of saving $100 per month), the system may determine the effect of the transaction, and based on the determined effect, limit the expenditure from the financial account. For example, the user may attempt to purchase a jacket with a credit card, but the virtual assistant may notify the credit card company to hold all transactions pending explicit authorization from the user. The system may then, via the virtual assistant, alert the user that the purchase of the jacket would prevent the user from attaining their savings goal for the month.

In the preceding example, the system may limit an expenditure entirely or partially. For example, if spending $100 on clothing would prevent the user from attaining a monthly savings goal, but the system determines the user could spend $20 and still hit the goal, the system may allow transactions of $20 or less to be charged to the user's credit card.

In some embodiments, the VA system may determine (210) and provide information for (215) goals for a user to approve based on one or more events associated with the user. For example, the system may recommend the user begin saving for college in response to the user's child having a birthday. The VA system can also tailor its alerts and recommendations to a user based on the customer's personality and mood, progress on goals, response to different tones (e.g., some users might want firm reminders, other users might want gentle reminders).

In some cases, the VA system may take various actions automatically or in response to user requests to help the user meet a goal. For a financial goal, for example, the VA may perform automatic balance transfers, bill payments, or other financial services. Likewise, the VA system may may provide automated alerts and request confirmation from user to perform an action (e.g., “You're about to overdraw your account, would you like me to transfer $100 from savings to checking? y/n”).

The system may generate a variety of different types of responses, recommendations, and other content. The system may provide (225) recommendations and responses to the user in a variety of different ways. In some embodiments, the system provides such content to a user in the same format (e.g., audio, text, etc.) as the user provides input to the VA system. In this context, a “response” or “recommendation” generally refers to any output provided by the system to the user. The virtual assistant system may provide a user information, perform a task, or take other action without a user necessarily providing any input.

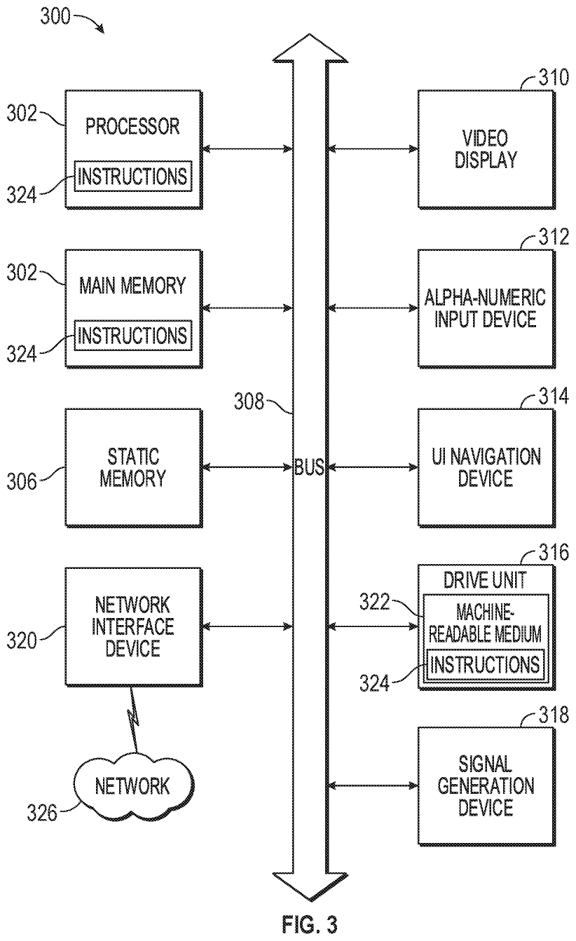

FIG. 3 is a block diagram illustrating exemplary components of a computing system 300 that may operate in conjunction with embodiments of the present disclosure. System 300 (in whole or in part) may be (or include) any of the computing devices 110, 120, 122, 130 shown in FIG. 1A. In this example, system 300 reads instructions 324 from a machine-readable medium (e.g., a tangible, non-transitory, machine-readable storage medium) 322 to perform a variety of functions, including any of the processes (in whole or in part) described herein.

System 300 can be connected (e.g., networked) to other machines. In a networked deployment, the system 300 can operate in the capacity of a server machine or a client machine in a server-client network environment, as well as a peer machine in a peer-to-peer (or distributed) network environment. System 300 may be (or include) a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 324, sequentially or otherwise, that specify actions to be taken by that machine. While only a single machine is illustrated in FIG. 3, the term “machine” or “system” as used herein may also include any number of different devices, systems, and/or machines that individually or jointly execute the instructions 324 to perform any one or more of the methodologies discussed herein. Additionally, alternate systems operating in conjunction with the embodiments of the present disclosure may have some, all, or multiples of the components depicted in FIG. 3.

In the example shown in FIG. 3, system 300 includes processor 302. Any processor may be used in conjunction with the embodiments of the present disclosure, such as a central processing unit (CPU), a graphics processing unit (GPU), a digital signal processor (DSP), an application specific integrated circuit (ASIC), a radio-frequency integrated circuit (RFIC), or any suitable combination thereof. System 300 further includes a main memory 304 and a static memory 306, which are configured to communicate with each other via a bus 308.

The system 300 further includes a user interface that may include a variety of components, including one or more output devices such as a graphics display 310 (e.g., a plasma display panel (PDP), a light emitting diode (LED) display, a liquid crystal display (LCD), a projector, or a cathode ray tube (CRT)). The user interface of the system 300 may also include any number of input devices and other components, including an alphanumeric input device 312 (e.g., a keyboard), a cursor control device 314 (e.g., a mouse, a touchpad, a trackball, a joystick, a motion sensor, or other pointing instrument), a storage unit 316, a signal generation device 318 (e.g., a speaker), and a network interface device 320.

The storage unit 316 includes a machine-readable medium 322 on which is stored the instructions 324 (e.g., software) embodying any one or more of the methodologies or functions described herein. The instructions 324 can also reside, completely or at least partially, within the main memory 304, within the processor 302 (e.g., within the processor's cache memory), or both, during execution thereof by the system 300. Accordingly, the main memory 304 and the processor 302 can be considered as machine-readable media. The instructions 324 can be transmitted or received over a network 326 via the network interface device 320.

As used herein, the term “memory” may refer to any machine-readable medium able to store data temporarily or permanently, including random-access memory (RAM), read-only memory (ROM), buffer memory, flash memory, and/or cache memory. While the machine-readable medium 322 is shown in this example as a single medium, the term “machine-readable medium” may include a single medium or multiple media (e.g., a centralized or distributed database, or associated caches and servers) able to store instructions 324. The term “machine-readable medium” may also include any medium, or combination of multiple media, that is capable of storing instructions (e.g., software) 324 for execution by a machine. Accordingly, a “machine-readable medium” refers to a single storage apparatus or device, as well as “cloud-based” storage systems or storage networks that include multiple storage apparatus or devices. The term “machine-readable medium” may also include one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific exemplary embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

1. A system comprising:
a processor; and
memory coupled to the processor and storing instructions that, when executed by the processor, cause the system to perform operations comprising:
receiving, by the system, information regarding a user in a plurality of information formats;
requesting, by the system, authorization from the user to access at least some of the information;
analyzing, via a virtual assistant operating on the system, the information regarding the user, the information including input to the virtual assistant by the user in a first format of the plurality of formats, a financial account associated with the user, and posts on social media sites by the user;
determining, based on the analysis of the information, a plurality of goals for the user;
assigning, by the system, a priority to each of the plurality of goals;
automatically selecting, by the system, a goal of the plurality of goals having a highest assigned priority using a weighted calculation, wherein the goal is related to a vacation preference of the user;
converting, by the system, at least some of the information to the first format:
providing, via the virtual assistant, the at least some of the information regarding the goal to the user using the first format;
monitoring, by the system, progress of the user in achieving the goal;
monitoring, by the system, vacation-related offers online using a network connection;
periodically automatically transferring, by the system, a variable amount from the financial account into a vacation fund account, the variable amount based on a balance of the financial account, a credit card balance of the user, and credit information about the user;
providing, via the virtual assistant, a recommendation to the user;
modifying, by the system, the goal and the recommendation based on the monitored progress, the modified recommendation based on successful behavior changes determined from a plurality of other users that accomplished the goal;
determining, by the system, a conflict between the goal of the user with a second goal of a second user of the virtual assistant related to the user;
limiting, by the system, an amount of a transaction by the user based on the recommendation, the monitored progress, and the conflict determination; and
automatically providing, by the virtual assistant operating on the system, an alert to the user when an online offer matching the vacation preference of the user is available.

2. The system of claim 1, wherein the information regarding the user includes geolocation information from a mobile computing device of the user.

3. The system of claim 1, wherein the input from the user includes one or more of: audio input, and text input.

4. The system of claim 1, wherein determining the goal for the user includes:
determining a plurality of goals for the user;
identifying a conflict between at least two of the goals in the plurality of goals; and
electing a goal from the plurality of goals based on the identified conflict.

5. The system of claim 4, wherein identifying the conflict between the at least two goals includes identifying a first goal associated with the user that conflicts with a second goal associated with a second user.

6. The system of claim 1, wherein providing the recommendation to the user is based on an analysis of a respective progress of a plurality of other users in achieving the goal.

7. The system of claim 1, wherein providing the recommendation to the user includes:
providing a first recommendation to the user at a first time via the virtual assistant;
determining, subsequent to the first time, that the user has failed to execute the first recommendation; and
in response to determining that the user has failed to execute the first recommendation, providing a second recommendation to the user at a second time via the virtual assistant.

8. The system of claim 1, wherein monitoring the progress of the user includes:
identifying an action the user is likely to take in the future;
determining an effect of the future action on achieving the goal; and
providing the recommendation to the user before the user takes the future action, the recommendation advising the user of the determined effect of the future action.

9. The system of claim 1, wherein monitoring the progress of the user includes:
identifying an action the user is likely to take in the future involving an expenditure from a financial account of the user;
determining an effect of the future action on achieving the goal; and
based on the determined effect of the action, limiting the expenditure from the financial account of the user.

10. A method comprising:
receiving, by a computer system, information regarding a user in a plurality of information formats;
requesting, by the computer system, authorization from the user to access at least some of the information;
analyzing, by the computer system via a virtual assistant operating on the computer system, the information regarding the user, the information including input to the virtual assistant by the user in a first format of the plurality of formats, a financial account associated with the user, and posts on social media sites by the user;
determining, by the computer system based on the analysis of the information, a plurality of goals for the user;
assigning, by the computer system, a priority to each of the plurality of goals;
automatically selecting, by the computer system, a goal of the plurality of goals having a highest assigned priority using a weighted calculation, wherein the goal is related to a vacation preference of the user;
converting, by the system, at least some of the information to the first format:
providing, by the computer system via the virtual assistant, the at least some of the information regarding the goal to the user using the first format;
monitoring, by the computer system, progress of the user in achieving the goal;
monitoring, by the computer system, vacation-related offers online using a network connection;
periodically automatically transferring, by the computer system, a variable amount from the financial account into a vacation fund account, the variable amount based on a balance of the financial account, a credit card balance of the user, and credit information about the user;
providing, via the virtual assistant, a recommendation to the user;
modifying, by the computer system, the goal and the recommendation based on the monitored progress, the modified recommendation based on successful behavior changes determined from a plurality of other users that accomplished the goal;
determining, by the computer system, a conflict between the goal of the user with a second goal of a second user of the virtual assistant related to the user;
limiting, by the computer system, an amount of a transaction by the user based on the recommendation, the monitored progress, and the conflict determination; and
automatically providing, by the virtual assistant operating on the computer system, an alert to the user when an online offer matching the vacation preference of the user is available.

11. The method of claim 10, wherein the information regarding the user includes geolocation information from a mobile computing device of the user.

12. The method of claim 10, wherein the input from the user includes one or more of: audio input, and text input.

13. The method of claim 10, wherein determining the goal for the user includes:
determining a plurality of goals for the user;
identifying a conflict between at least two of the goals in the plurality of goals; and
selecting a goal from the plurality of goals based on the identified conflict.

14. The method of claim 13, wherein identifying the conflict between the at least two goals includes identifying a first goal associated with the user that conflicts with a second goal associated with a second user.

15. The method of claim 10, wherein providing the recommendation to the user is based on an analysis of a respective progress of a plurality of other users in achieving the goal.

16. The method of claim 10, wherein providing the recommendation to the user includes:
providing a first recommendation to the user at a first time via the virtual assistant;
determining, subsequent to the first time, that the user has failed to execute the first recommendation; and
in response to determining that the user has failed to execute the first recommendation, providing a second recommendation to the user at a second time via the virtual assistant.

17. The method of claim 10, wherein monitoring the progress of the user includes:
identifying an action the user is likely to take in the future;
determining an effect of the future action on achieving the goal; and
providing the recommendation to the user before the user takes the future action, the recommendation advising the user of the determined effect of the future action.

18. The method of claim 10, wherein monitoring the progress of the user includes:
identifying an action the user is likely to take in the future involving an expenditure from a financial account of the user;
determining an effect of the future action on achieving the goal; and
based on the determined effect of the action, limiting the expenditure from the financial account of the user.

19.-20. (canceled)
